(19) United States
(12) Patent Application Publication
(10) Pub. No.: US 2022/0164825 A1
(43) Pub. Date: May 26, 2022

(54) INFORMATION PROCESSING APPARATUS AND SYSTEM AND NON-TRANSITORY COMPUTER READABLE MEDIUM FOR OUTPUTTING INFORMATION TO USER TERMINALS

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/328,083

(22) Filed: May 24, 2021

(30) Foreign Application Priority Data
Nov. 20, 2020 (JP) 2020-193755

(51) Int. Cl. G06Q 30/02

(52) U.S. Cl. CPC G06Q 30/0251; G06Q 30/0277

(57) ABSTRACT

An information processing apparatus includes a processor configured to output identical advertising information to plural users using an identical online service.

### CROSS-REFERENCE TO RELATED APPLICATIONS

This application is based on and claims priority under 35 USC 119 from Japanese Patent Application No. 2020-193755 filed Nov. 20, 2020.

### BACKGROUND

### (i) Technical Field

The present disclosure relates to an information processing apparatus and system and a non-transitory computer readable medium.

### (ii) Related Art

A technology for providing an online service is known. Japanese Unexamined Patent Application Publication No. 2002-41645 discloses a method for providing targeted advertising to a user based on user's preference.

Japanese Unexamined Patent Application Publication (Translation of PCT Application) No. 2011-513803 discloses a method for providing targeted television (TV) advertising to a user based on information about user's online access.

Japanese Unexamined Patent Application Publication No. 2020-53053 discloses a system for assisting in distributing advertising to a target audience constituted by one or more targets having a predetermined attribute.

Japanese Unexamined Patent Application Publication (Translation of PCT Application) No. 2010-520564 discloses a method for improving the overall performance or effectiveness of online advertising by modifying online advertising.

### SUMMARY

Aspects of non-limiting embodiments of the present disclosure relate to an information processing apparatus and system and a non-transitory computer readable medium that are able to provide the same information to plural users using an online service.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to output identical advertising information to plural users using an identical online service.

### BRIEF DESCRIPTION OF THE DRAWINGS

An exemplary embodiment of the present disclosure will be described in detail based on the following figures, wherein:

FIG. 1 is a block diagram illustrating an example of the configuration of an information processing system according to the exemplary embodiment;

FIG. 2 is a block diagram illustrating an example of the configuration of a server according to the exemplary embodiment;

FIG. 3 is a block diagram illustrating an example of the configuration of a terminal apparatus according to the exemplary embodiment;

FIG. 4 illustrates a screen;

FIG. 5 illustrates a screen;

FIG. 6 illustrates a screen;

FIG. 7 illustrates a screen;

FIG. 8 illustrates a screen;

FIG. 9 illustrates a screen;

FIG. 10 illustrates a screen;

FIG. 11 illustrates a screen;

FIG. 12 illustrates a screen;

FIG. 13 illustrates a screen;

FIG. 14 illustrates a screen;

FIG. 15 illustrates a screen;

FIG. 16 illustrates screens; and

FIG. 17 illustrates screens.

### DETAILED DESCRIPTION

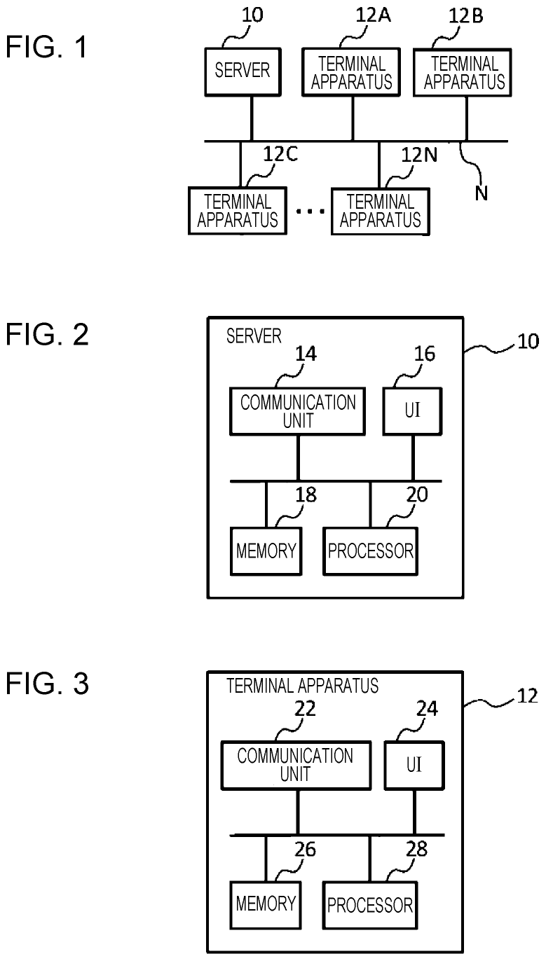

An information processing system according to an exemplary embodiment will be described below with reference to FIG. 1. FIG. 1 illustrates an example of the configuration of the information processing system according to the exemplary embodiment.

The information processing system according to the exemplary embodiment includes a server 10 and N (N is an integer of one or greater) terminal apparatuses 12. In the example in FIG. 1, twelve terminal apparatuses 12A, 12B, 12C, . . . , and 12N are included in the information processing system. However, this is only an example, and at least one terminal apparatus may be included in the information processing system. Hereinafter, the terminal apparatuses 12A, 12B, 12C, . . . , and 12N will simply be called the terminal apparatus 12 or the terminal apparatuses 12 unless it is necessary to distinguish them from each other. The information processing system may include a device other than the server 10 and the terminal apparatuses 12.

The server 10 and the terminal apparatuses 12 each have a function of communicating with another device by using a wired medium, such as a cable, or a wireless medium. That is, the server 10 and the terminal apparatuses 12 may be each physically connected to another device via a cable and send and receive information with this device, or may send and receive information with another device by wireless communication. Examples of wireless communication are short-range wireless communication and Wi-Fi (registered trademark). Examples of short-range wireless communication are Bluetooth (registered trademark), radio frequency identifier (RFID), and near field communication (NFC). The server 10 and the terminal apparatuses 12 may alternatively communicate with another device via a communication channel N, such as a local area network (LAN) or the Internet.

The server 10 provides online services. A user can receive an online service by using the terminal apparatus 12. A user can also use individual items of services provided by an online service.

For example, the server 10 sets a user having registered his/her account information (such as a user ID and a password) in an online service as a user authorized to use this service, and then provides the online service to this user. For a user having made a request to use an online service without registering his/her account information, the server 10 may set such a user as a guest user and provide the online service to this user.

Examples of online services are an online meeting, a service for providing an application online, a service for providing the content online, an online game, an online shopping, a social media service, and a combination thereof. Another service may be provided online.

An online meeting is also called a web meeting, a remote meeting, or a teleconferencing. A user can exchange information with another user by using an online meeting.

Examples of applications are a document creating application, a spreadsheet application, a presentation application, and a combination thereof. Other applications, such as an application that enables a user to exchange information with another user online and an application that enables plural users to work together online, may be provided to a user.

Examples of types of the content are entertainments (such as concerts, theaters, movies, video, and music), sports, and esports. An online video streaming service and an online music streaming service are examples of a service for providing the content online. A user can enjoy entertainments, sports, and esports online.

Examples of online games are puzzle games, fighting games, racing games, combat games, sport games, simulation games, and role playing games. These games may be a player-versus-player (PvP) game or a team (multiplayer)-participating game.

An online service may be a service using a virtual space or a service which does not use a virtual space. The concept of a virtual space is contrast to a real space and may be a computer-simulated virtual space, a virtual space constructed on a network, such as the Internet, a virtual space implemented by a virtual reality (VR) technology, or a cyberspace. A virtual three-dimensional or two-dimensional space is an example of a virtual space. A building or an organism in a real space may be recreated in a virtual space. For example, a real townscape may be recreated in a virtual space.

Examples of information to be exchanged or provided by an online service are image data, such as still image data and video image data, data indicating character strings of a message or a comment, for example (such as document data and text data), sound data, such as music data, control data for controlling a device, and a combination thereof.

An automated response system, such as a chatbot, may participate in an online service, and a user may exchange information with the automated response system. For example, the automated response system serves as a response assistant which responds to a query from a user. The automated response system receives a message from a user, analyzes the content of the message, creates a response to the message, and gives this response to the user. The automated response system is implemented by executing a program, for example. The program is stored in the server 10 or another device, such as another server or the terminal apparatus 12. The automated response system may be implemented by artificial intelligence (AI). Any type of algorithm may be used for AI.

The server 10 stores and manages account information about a user using an online service. Account information is information for a user to log in an online service and to use it. Account information indicates a user ID and a password, for example. A user sends his/her account information to the server 10 and logs in an online service. If this account information is found to match that stored in the server 10, the user is allowed to use the online service. A user who does not register his/her account information in an online service may also be able to use the online service. A guest user is an example of such a user.

The server 10 also outputs information for drawing user's attention to a user using an online service. For example, the server 10 outputs such information to multiple users using the same online service. Examples of information for drawing user's attention are advertising information, information for giving an alarm to a user, information for guiding a user, information for showing a route to a user, and another type of information. Advertising information is used for advertising a product, a service, people, a business, or another item for a commercial or non-commercial purpose. Hereinafter, information for drawing user's attention will be called attention drawing information.

Attention drawing information is represented in the form of text, an image, sound or voice, vibration, or a combination thereof.

Outputting attention drawing information is to display such information as text or an image on a display, output such information as sound from a speaker, transmit such information as vibration, or a combination thereof.

For example, the same attention drawing information is displayed on the displays of the terminal apparatuses 12 of multiple users using the same online service, or is output from the speakers used by the users, or is notified to the users as vibration.

The server 10 may store and manage information about attributes of a user using an online service. Information about attributes of a user will be called attribute information. Attribute information about a user is included in account information about this user, for example, and is stored in the server 10. Attribute information may not be stored in the server 10.

Examples of attributes of a user are the gender, age, profession, company, department, job type, hobbies, favorites, height, weight, blood type, birthplace, address, qualifications, and contact details (such as a telephone number, email address, and social media account). Another attribute may be used.

To use an online service, registering of attributes of a user in the server 10 is optional. That is, to use an online service, a user may or may not register his/her attributes in the server 10. Attributes registered in the server 10 may be some or all of the above-described attributes.

Examples of the terminal apparatuses 12 are personal computers (PCs), tablet PCs, smartphones, wearable devices (such as augmented reality (AR) glasses, virtual reality (VR) glasses, and bearable devices), devices having a function of transmitting information by vibration, and cellular phones. To use an online service, a user uses the terminal apparatus 12. For example, the user inputs his/her account information into the terminal apparatus 12, and then, the account information is sent to the server 10. If user authentication succeeds, the user is able to log in the online service.

In the exemplary embodiment, N (N is an integer of one or greater) users use an online service. Each user uses an online service by operating his/her terminal apparatus 12. For example, user A uses a terminal apparatus 12A, user B uses a terminal apparatus 12B, a user C uses a terminal apparatus 12C, . . . , and a user N uses a terminal apparatus 12N.

User A uses the terminal apparatus 12A to log in an online service and to use it. The other users also individually use their terminal apparatuses 12 to log in an online service and to use it. Plural users may use the same terminal apparatus 12 to separately log in an online service. For example, user A and user B may operate the same terminal apparatus 12A to separately log in an online service.

An example of the hardware configuration of the server 10 will be described below with reference to FIG. 2.

The server 10 includes a communication unit 14, a user interface (UI) 16, a memory 18, and a processor 20.

The communication unit 14 is a communication interface having a communication chip and a communication circuit, and has a function of sending data to another device and a function of receiving data from another device. The communication unit 14 has either one of a wireless communication function and a wired communication function. The communication unit 14 may communicate with another device by using short-range wireless communication or via the communication channel N.

The UI 16 includes at least one of a display and an operation unit. The display is a liquid crystal display or an electroluminescence (EL) display, for example. The operation unit is a keyboard, input keys, or an operation panel, for example. The UI 16 may be a touchscreen having both functions as a display and an operation unit.

The memory 18 is a device having one or multiple storage regions for storing various types of data. The memory 18 is a hard disk drive (HDD), various memory units (such as a random access memory (RAM), a dynamic random access memory (DRAM), and a read only memory (ROM)), another type of storage device (such as an optical disc), or a combination thereof. The memory 18 included in the server 10 is constituted by one or plural memory devices.

In the memory 18, user account information about a user authorized to use an online service is stored. Such account information may be stored in a device other than the server 10, such as in an authentication server. A user trying to log in an online service is authenticated by an authentication server, for example, and if authentication succeeds, the server 10 provides an online service to the user.

Attention drawing information may be stored in the memory 18. Alternatively, attention drawing information may not be stored in the memory 18 or may be stored in the memory 18 and also in another device.

The processor 20 controls the operations of the individual elements of the server 10. The processor 20 may include a memory.

In the exemplary embodiment, the processor 20 provides an online service to a user. The processor 20 also outputs attention drawing information to a user using an online service. For example, the processor 20 outputs the same attention drawing information to plural users using the same online service.

An example of the hardware configuration of the terminal apparatus 12 will be described below with reference to FIG. 3.

The terminal apparatus 12 includes a communication unit 22, a UI 24, a memory 26, and a processor 28.

The communication unit 22 is a communication interface having a communication chip and a communication circuit, and has a function of sending data to another device and a function of receiving data from another device. The communication unit 22 has either one of a wireless communication function and a wired communication function. The communication unit 22 may communicate with another device by using short-range wireless communication or via the communication channel N.

The UI 24 includes at least one of a display and an operation unit. The display is a liquid crystal display or an EL display, for example. The operation unit is a keyboard, input keys, or an operation panel, for example. The UI 24 may be a touchscreen having both functions as a display and an operation unit. The UI 24 may include a microphone and a speaker.

The memory 26 is a device having one or multiple storage regions for storing various types of data. The memory 26 is an HDD, various memory units (such as a RAM, a DRAM, and a ROM), another type of storage device (such as an optical disc), or a combination thereof. The memory 26 included in the terminal apparatus 12 is constituted by one or plural memory devices.

The processor 28 controls the operations of the individual elements of the terminal apparatus 12. The processor 28 may include a memory.

The processor 28 performs control to display an image or text provided by an online service on the display of the terminal apparatus 12, to output voice or music provided by an online service from a speaker, and to supply information provided by an online service to a user as vibration.

Examples of the exemplary embodiment will be discussed below. In each example, the processor 20 of the server 10 or the processor 28 of the terminal apparatus 12 may execute processing or the processors 20 and 28 may execute processing together. One part of processing may be executed by the processor 20, and another part of the processing may be executed by the processor 28. The server 10, the terminal apparatus 12, or a combination thereof corresponds to an example of an information processing apparatus according to the exemplary embodiment.

### First Example

A first example will be discussed below.

In the first example, it is assumed that user A and user B use the same online service. For example, user A operates the terminal apparatus 12A to log in the online service and to use it, while user B operates the terminal apparatus 12B to log in the same online service and to use it. The terminal apparatus 12A corresponds to an example of a first terminal apparatus, while the terminal apparatus 12B corresponds to an example of a second terminal apparatus. The processor 28 of the terminal apparatus 12A corresponds to an example of a first processor, while the processor 28 of the terminal apparatus 12B corresponds to an example of a second processor.

The processor 20 of the server 10 outputs the same attention drawing information to user A and user B using the same online service. More specifically, the processor 20 of the server 10 sends the same attention drawing information to the terminal apparatuses 12A and 12B and also sends information indicating an instruction to output the attention drawing information to the terminal apparatuses 12A and 12B. The instruction to output the attention drawing information may be included in the attention drawing information. Upon receiving the attention drawing information from the server 10, the processor 28 of the terminal apparatus 12A performs control to display this information on the display of the terminal apparatus 12A, to output this information from the speaker of the terminal apparatus 12A or that of user A as sound, or to notify this information to user A by vibration. Likewise, upon receiving the attention drawing information from the server 10, the processor 28 of the terminal apparatus 12B performs control to display this information on the display of the terminal apparatus 12B, to output this information from the speaker of the terminal apparatus 12B or that of user B as sound, or to notify this information to user B by vibration. In this manner, the same attention drawing information is provided to user A and user B.

That is, when the online service used in the terminal apparatus 12A is also used in the terminal apparatus 12B, the processor 28 of the terminal apparatus 12A outputs the same attention drawing information as that to the terminal apparatus 12B. Likewise, when the online service used in the terminal apparatus 12B is also used in the terminal apparatus 12A, the processor 28 of the terminal apparatus 12B outputs the same attention drawing information as that to the terminal apparatus 12A.

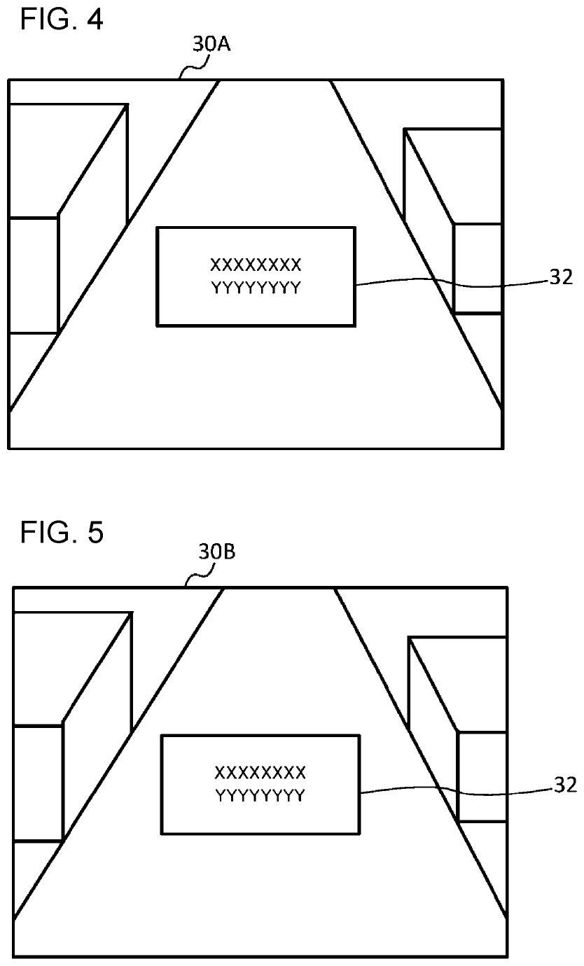

The first example will be explained below in detail with reference to FIGS. 4 and 5. FIG. 4 shows a screen 30A displayed on the display of the terminal apparatus 12A. FIG. 5 shows a screen 30B displayed on the display of the terminal apparatus 12B.

User A and user B use the same online service. By using this online service, an online space (a virtual space, for example) that multiple users can share is provided to these users. User A and user B can share this online space provided by the online service. For example, user A and user B log in the same online game and play this game by sharing the same online space provided by the online game. It is now assumed that user A and user B are playing the same online game.

User A or user B may use the online game as a guest user. For example, if user A having logged in the online game invites user B who has not logged in, user B may be able to participate in the game as a guest user without performing a required login operation. In this case, account information about user A and that about user B (such as a user ID for identifying user B) are linked with each other and managed by the server 10. When user A logs out of the online game, the processor 20 of the server 10 may cause user B also to log out and stop user B from using the online game or may allow user B to continue using the online game.

The processor 20 of the server 10 sends data indicating the image of the online game for user A to the terminal apparatus 12A, and the processor 28 of the terminal apparatus 12A displays this image on the screen 30A. Likewise, the processor 20 of the server 10 sends data indicating the image of the online game for user B to the terminal apparatus 12B, and the processor 28 of the terminal apparatus 12B displays this image on the screen 30B. The processor 20 of the server 10 may perform image display control.

The processor 20 of the server 10 also sends the same attention drawing information to the terminal apparatuses 12A and 12B. The processor 28 of the terminal apparatus 12A displays this information on the screen 30A, while the processor 28 of the terminal apparatus 12B displays this information on the screen 30B. As an example of the attention drawing information, advertising information is sent to the terminal apparatuses 12A and 12B and is displayed on the displays of the terminal apparatuses 12A and 12B.

Advertising information 32 is displayed on the screen 30A, as shown in FIG. 4, and is also displayed on the screen 30B, as shown in FIG. 5. That is, the same advertising information 32 is displayed on the screens 30A and 30B. The advertising information 32 is an image or text, for example. Instead of or in addition to displaying advertising information, the advertising information may be output from a speaker or be notified to a user by vibration.

When user A and user B are playing the same PvP online game, for example, the same advertising information 32 is displayed on the screens 30A and 30B.

The processor 20 of the server 10 may output the same attention drawing information to users using the same online service in the same span of time.

For example, if user A and user B are logging in the same online game in the same span of time, the processor 20 of the server 10 sends the same advertising information 32 to the terminal apparatuses 12A and 12B. Then, the same advertising information 32 is displayed on the screens 30A and 30B in the same span of time.

The advertising information 32 may be information concerning targeted advertising. The content of the advertising information 32 may be determined based on an attribute of a user, such as the attribute common to user A and user B, an attribute of one of user A and user B, or an attribute of one of user A and user B who is in a better position in the online game than the other user. The content of the advertising information 32 may be determined based on the playing content of each of user A and user B or the content of the online service used by user A and user B. The content of the advertising information 32 may be determined by the processor 20 of the server 10 or a device other than the server 10, such as the device of an advertiser (a person or a company such as an advertising agency). Alternatively, the content of the advertising information 32 may be determined randomly.

As discussed above, since the same advertising information 32 is provided to user A and user B, they can share the same advertising information 32. For example, user A and user B may discuss or talk about the same advertisement. The advertising information 32 shown in FIGS. 4 and 5 is an advertisement for food (such as food delivery), for example.

If user A has performed a certain operation (clicking, for example) on the advertising information 32, the processor 28 of the terminal apparatus 12A may display information to be advertised based on the advertising information 32 on the screen 30A. For example, the uniform resource locator (URL) of a website of a product or a store related to the advertising information 32 is linked with the advertising information 32, and when user A has clicked on the advertising information 32, for example, the processor 28 of the terminal apparatus 12A accesses the URL and displays the website on part of or entirety of the screen 30A. In the terminal apparatus 12B, operation is performed in a similar manner.

Advertising information may be output for a charge or free for an advertiser. If output of advertising information is charged, information about the payment methods for an advertising fee and about the charging system are linked with advertising information, and the advertiser is charged based on this information.

In the above-described example, user A and user B use the same online game. If user A and user B use an online service other than an online game, the same advertising information is output in a similar manner.

For the sake of description, an example in which two users (user A and user B) use the same online service has been discussed. When three or more users use the same online service, the same attention drawing information is output to these users in a similar manner.

If an online service is available for a charge or free, the processor 20 of the server 10 may not output attention drawing information to a user paying for the online service and output attention drawing information to a user using the online service for free.

For example, if user A pays a fee for the online game, the processor 20 of the server 10 does not send the advertising information 32 to the terminal apparatus 12A. In this case, the advertising information 32 is not displayed on the screen 30A. This allows user A to concentrate on playing the game without being disturbed by the advertising information 32. If user B uses the online game for free, the processor 20 sends the advertising information 32 to the terminal apparatus 12B. In this case, the advertising information 32 is displayed on the screen 30B, as shown in FIG. 5.

The concept of paying for an online service includes paying for the online service itself, paying for part of the online service, and purchasing information or items provided by the online service.

The processor 20 of the server 10 may output attention drawing information to a user paying for an online service and may not output attention drawing information to a user using the online service for free.

For example, if user A pays for using the online game, the processor 20 of the server 10 sends the advertising information 32 to the terminal apparatus 12A. In this case, the advertising information 32 is displayed on the screen 30A. If user B uses the online game for free, the processor 20 does not send the advertising information 32 to the terminal apparatus 12B. In this case, the advertising information is not displayed on the screen 30B.

For example, if a real townscape is recreated in an online space of an online service, such as an online game, the townscape in the online space looks more realistic if advertisements placed in the real townscape are also recreated in the online space. This makes a user feel as if he/she were in the real space. That is, recreating actual advertisements in the online space allows a user to enjoy a sense of reality. In other words, providing advertising information in the real space to a user makes the user enjoy a more realistic feeling. Additionally, an advertiser having provided the advertisement and a company having provided the online service can make a profit. For example, an actual advertisement in a real space (such as an advertisement with a registered trademark) may be prohibited from being provided for free due to limitations of a contract or a law. If a user pays a fee, such an advertisement can be displayed in an online space and the user can also enjoy a more realistic feeling.

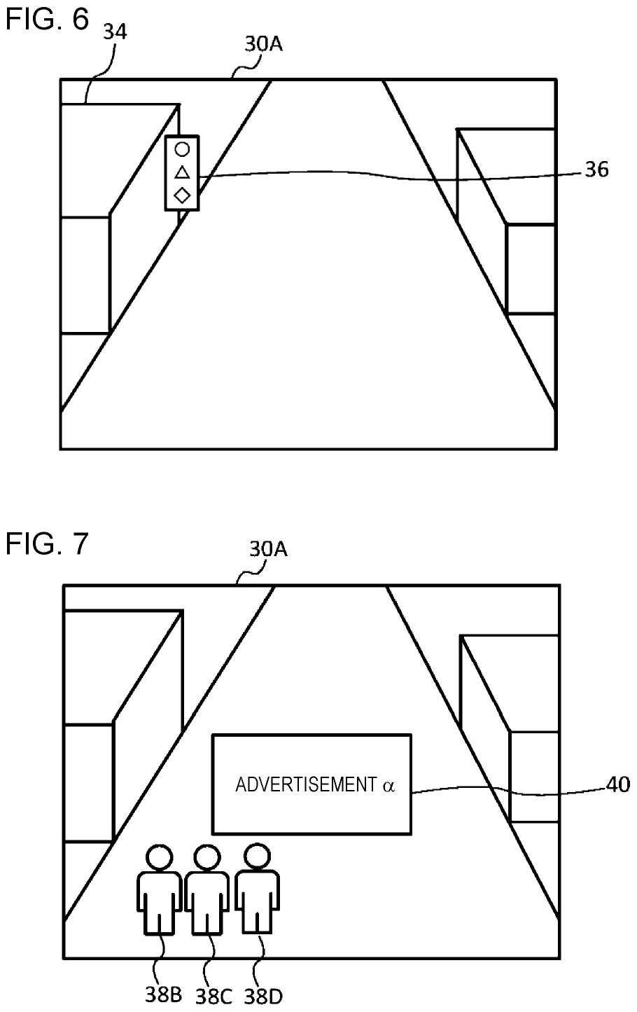

FIG. 6 illustrates an example in which an actual advertisement in a real space is recreated in an online space. On the screen 30A displayed on the display of the terminal apparatus 12A, an image of a building 34 and that of a road in a real space are displayed. User A is using an online game by paying a fee. In this case, the processor 20 of the server 10 sends advertising information indicating an actual advertisement in the real space to the terminal apparatus 12A. The advertising information is displayed on the screen 30A. For example, an advertising sign 36 placed on the building 34 is an advertising sign placed on the actual building in the real space, and the image of the advertising sign 36 is displayed on the screen 30A. In this manner, a townscape in a real space is recreated in the online space.

In contrast, an advertisement in the real space is not provided to a user using the online game for free. Instead of the image of the advertising sign 36, an image of an advertising sign with a fictitious trademark, for example, is displayed.

Processing in the first example may be executed in an online service other than an online game. For example, if multiple users are participating in the same online meeting, the same attention drawing information, such as the same advertising information, is provided to the multiple users. In another example, if plural users are receiving the content, such as a concert, a live show, or a movie, online, the same attention drawing information is provided to these users.

### Second Example

A second example will be discussed below.

In the second example, one or plural users using the same online service is formed into a group. The processor 20 of the server 10 outputs the same attention drawing information to plural users in the same group.

Multiple users using the same online service may form a group at their discretion. The processor 20 of the server 10 may make multiple users having the same attribute or related attributes belong to the same group.

It is assumed that, as in the first example, plural users are using the same online game and sharing an online space of the online game. In this case, the users may form a team to play the game as a group.

In one example, users A, B, C, D, E, F, G, and H are using the same online game and sharing the same online space. Users A, B, C, and D belong to group A, while users E, F, G, and H belong to group B.

The processor 20 of the server 10 outputs the same attention drawing information (advertising information, for example) to users A, B, C, and D belonging to group A, and outputs the same attention drawing information to users E, F, G, and H belonging to group B. The attention drawing information output to group A and that to group B may be the same piece of information or may be different pieces of information.

It is assumed that the terminal apparatus 12A is used by user A, the terminal apparatus 12B is used by user B, the terminal apparatus 12C is used by user C, the terminal apparatus 12D is used by user D, the terminal apparatus 12E is used by user E, the terminal apparatus 12F is used by user F, the terminal apparatus 12G is used by user G, and the terminal apparatus 12H is used by user H. On the displays of the terminal apparatuses 12, individual images of the online game are displayed.

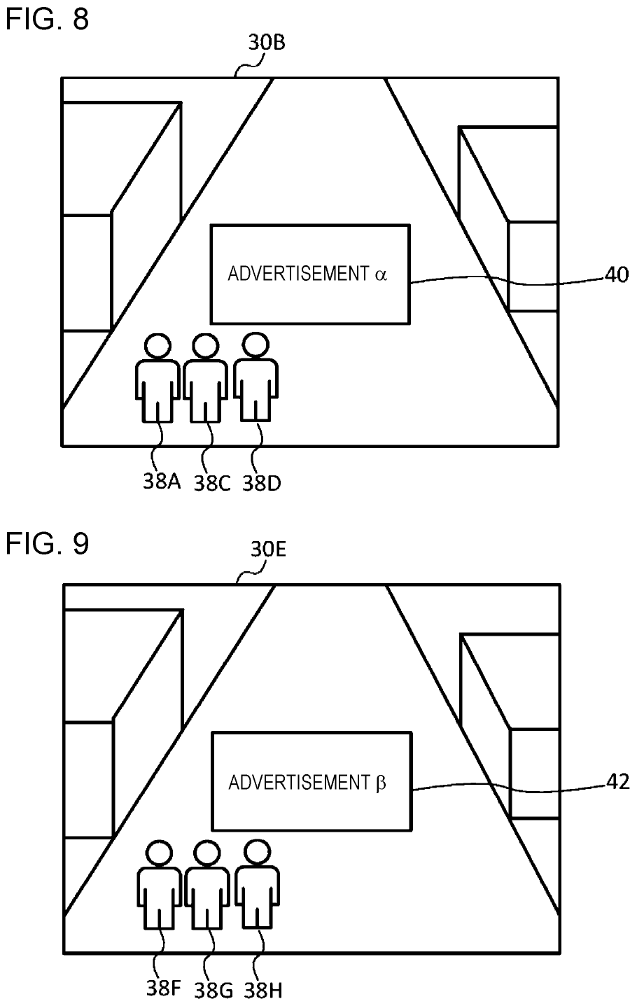

The second example will be discussed below in detail with reference to FIGS. 7, 8, and 9. FIG. 7 illustrates a screen 30A displayed on the display of the terminal apparatus 12A operated by user A. FIG. 8 illustrates a screen 30B displayed on the display of the terminal apparatus 12B operated by user B. FIG. 9 illustrates a screen 30E displayed on the display of the terminal apparatus 12E operated by user E.

On the screen 30A shown in FIG. 7, the image of the online game for user A is displayed. Player images of users B, C, and D in group A are also displayed on the display 30A. An image 38B is an image of user B, an image 38C is an image of user C, and an image 38D is an image of user D. The image of user A may also be displayed on the screen 30A. Since users A, B, C, and D belong to the same group A, the image 38B of user B, the image 38C of user C, and the image 38D of user D are displayed together on the screen 30A of user A.

On the screen 30B shown in FIG. 8, the image of the online game for user B is displayed. Player images of users A, C, and D in group A are also displayed on the display 30B. An image 38A is an image of user A, an image 38C is an image of user C, and an image 38D is an image of user D. The image of user B may also be displayed on the screen 30B. Since users A, B, C, and D belong to the same group A, the image 38A of user A, the image 38C of user C, and the image 38D of user D are displayed together on the screen 30B of user B.

On the display of the terminal apparatus 12C of user C and that of the terminal apparatus 12D of user D, player images of the individual users in group A are displayed in a manner similar to those on the screens 30A and 30B.

On the screen 30E shown in FIG. 9, the image of the online game for user E is displayed. Player images of users F, G, and H in group B are also displayed on the display 30E. An image 38F is an image of user F, an image 38G is an image of user G, and an image 38H is an image of user H. The image of user E may also be displayed on the screen 30E. Since users E, F, G, and H belong to the same group B, the image 38F of user F, the image 38G of user G, and the image 38H of user H are displayed together on the screen 30E of user E.

On the displays of the terminal apparatus 12F of user F, the terminal apparatus 12G of user G, and the terminal apparatus 12H of user H, player images of the individual users in group B are displayed in a manner similar to those on the screen 30E.

Player images may not necessarily be displayed. Depending on the content of the online game, player images may be displayed or may not be displayed.

The processor 20 of the server 10 sends the same attention drawing information to the terminal apparatuses 12A, 12B, 12C, and 12D and sends the same attention drawing information to the terminal apparatuses 12E, 12F, 12G, and 12H. As an example of attention drawing information, advertising information is sent to the individual terminal apparatuses 12.

The same advertising information is displayed on the displays of the terminal apparatuses 12A, 12B, 12C, and 12D. The same advertising information is displayed on the displays of the terminal apparatuses 12E, 12F, 12G, and 12H.

As shown in FIG. 7, advertising information 40 is displayed on the screen 30A of user A, and as shown in FIG. 8, the advertising information 40 is displayed on the screen 30B of user B. The advertising information 40 is also displayed on the displays of the terminal apparatuses 12C and 12D, though it is not shown. The advertising information 40 displayed on the displays of the terminal apparatuses 12A, 12B, 12C, and 12D are the same advertising information. The advertising information 40 indicates an image of an advertisement α, for example. In this manner, the advertising information indicating the same advertisement α is provided to users A, B, C, and D belonging to the same group A. The advertising information 40 may be provided to users A, B, C, and D in the same span of time.

The content of advertisement α may be determined based on attributes of users belonging to group A or based on a factor other than the attributes of the users.

As shown in FIG. 9, advertising information 42 is displayed on the screen 30E of user E. The advertising information 42 is also displayed on the displays of the terminal apparatuses 12F, 12G, and 12H, though it is not shown. The advertising information 42 displayed on the displays of the terminal apparatuses 12E, 12F, 12G, and 12H are the same advertising information. The advertising information 42 indicates an image of an advertisement β, for example. In this manner, the advertising information indicating the same advertisement β is provided to users E, F, G, and H belonging to the same group B. The advertising information 42 may be provided to users E, F, G, and H in the same span of time.

The content of advertisement β may be determined based on attributes of users belonging to group B or based on a factor other than the attributes of the users.

The processor 20 of the server 10 may output the same attention drawing information to plural groups related to each other. Plural groups related to each other are groups interacting with each other using the same online service. Interacting means joining together, conversing with each other, and competing with each other in an online game, for example.

If group A and group B join together or compete with each other in the same online game, the processor 20 of the server 10 outputs the same attention drawing information (advertising information, for example) to group A and group B. More specifically, the processor 20 outputs the same attention drawing information to the terminal apparatuses 12A through 12H. Then, this information is displayed on the displays of the terminal apparatuses 12A through 12H.

An example of attention drawing information to be displayed after plural groups have joined together will be discussed below with reference to FIG. 10. FIG. 10 illustrates a screen 30A displayed on the display of the terminal apparatus 12A of user A.

If group A and group B have joined together in an online game, advertising information 44 is displayed on the screen 30A. The advertising information 44 is also displayed on the displays of the terminal apparatuses 12B through 12H, though it is not shown. The advertising information 44 displayed on the displays of the terminal apparatuses 12A through 12H are the same advertising information. The advertising information 44 indicates an image of an advertisement γ, for example. In this manner, when group A and group B have joined together, the advertising information indicating the same advertisement γ is provided to users A through H. The advertising information 44 may be provided to users A through H in the same span of time.

When group A and group B start interacting with each other, for example, the advertising information 40 representing the advertisement α provided to the users in group A is switched to the advertising information 44 representing the advertisement γ, while the advertising information 42 representing the advertisement β provided to the users in group B is switched to the advertising information 44 representing the advertisement γ. The switching timing of advertising information is a timing at which a user in group A has suggested to a user in group B that group A and group B interact with each other or a timing at which a user in group B has responded to the user in group A and group A and group B have started interacting with each other.

For example, if a user in group A and a user in group B are in the same place or the same scene or physically close to each other (within a certain distance), the timing at which the user in group A has started speaking to the user in group B is a timing at which the user in group A has suggested to the user in group B that group A and group B interact with each other. If the user in group B has responded to the user in group A and agreed to interact with group A, group A and group B start interacting with each other (they join together, for example). If a user in group B suggests interacting with group A, group A and group B can start interacting in a similar manner. Switching of the advertisement may be performed at a timing at which a user in group A or group B has suggested interacting with each other or a timing at which group A and group B have actually started interacting.

In another example, if a user in group A and a user in group B are in the same place or the same scene or physically close to each other, group A and group B may automatically start interacting with each other and the advertisement may be switched accordingly.

When the interaction of groups has finished, the processor 20 of the server 10 switches attention drawing information back to the original information. In the above-described example, the processor 20 switches the advertising information 44 back to the advertising information 40 provided to the users in group A and back to the advertising information 42 provided to the users in group B. Then, the advertisement α is provided to the users in group A, while the advertisement β is provided to the users in group B.

The content of advertisement γ may be determined based on attributes of users belonging to group A or group B or based on a factor other than the attributes of the users.

If plural groups are related to each other, the processor 20 of the server 10 may change a piece of attention drawing information to be provided to these groups, based on how they are related to each other. A determination regarding how plural groups are related is made based on the hierarchical relationship between the groups or the number of users in each group.

For example, the processor 20 determines attention drawing information to be provided to plural groups interacting with each other, based on attributes of users in a group including a larger number of users. This will be explained by taking a specific example. It is now assumed that more users belong to group A than to group B. When group A and group B interact with each other, the processor 20 provides attention drawing information (advertising information, for example) determined based on attributes of the users in group A to the users in group A and in group B. For example, advertising information about an advertisement for a hobby of users in group A is provided to the users in group A and in group B.

When a user has performed a certain operation on attention drawing information, the processor 20 may output information to be advertised based on the attention drawing information to the group of this user.

In the example in FIG. 7, when user A in group A has performed a certain operation (clicking, for example) on the advertising information 40, the processor 20 of the server 10 sends information to be advertised based on the advertising information 40 to the terminal apparatuses 12A, 12B, 12C, and 12D. Then, this information is displayed on the displays of the terminal apparatuses 12A, 12B, 12C, and 12D, and users A, B, C, and D in group A can share the same information.

For example, if the URL of a website of a product or a store is linked with the advertising information 40, in response to user A having clicked on the advertising information 40, the processor 20 accesses the website and displays it on the displays of the terminal apparatuses 12A, 12B, 12C, and 12D.

In another example, when user A has clicked on the advertising information 40, the processor 28 of the terminal apparatus 12A accesses the URL and displays the website on the screen 30A. Information that user A has clicked on the advertising information 40 is sent from the terminal apparatus 12A to the terminal apparatuses 12B, 12C, and 12D via the server 10. The processors 28 of the terminal apparatuses 12B, 12C, and 12D access the URL and display the website on the displays of the terminal apparatuses 12B, 12C, and 12D.

In this manner, when a user in a certain group has performed a certain operation on attention drawing information, information (a website, for example) to be advertised based on this attention drawing information is provided to all the users in this group.

When a user in a certain group has performed a certain operation on attention drawing information, information (a website, for example) to be advertised based on this attention drawing information may be provided only to this user and may not be provided to the other users in the group. It may be determined whether to provide to the other users in a group every time a user performs a certain operation on attention drawing information.

In the above-described example, when user A has clicked on the advertising information 40, a website about a product or a store is displayed on the display of the terminal apparatus 12A and is not displayed on the displays of the terminal apparatuses 12B, 12C, and 12D.

If an online service is available for a charge or free, the processor 20 of the server 10 may not output attention drawing information to a group including a user paying for the online service. A user paying for using an online service will be called a paying user.

If a group includes even one paying user, the processor 20 may not output attention drawing information to this group and output attention drawing information to a group without any paying user. Alternatively, if a group includes at least a predetermined number of paying users, the processor 20 may not output attention drawing information to this group. If a group includes less than the predetermined number of paying users, the processor 20 may output attention drawing information to this group. The processor 20 may determine whether to output attention drawing information to a group in accordance with the charging fee for this entire group.

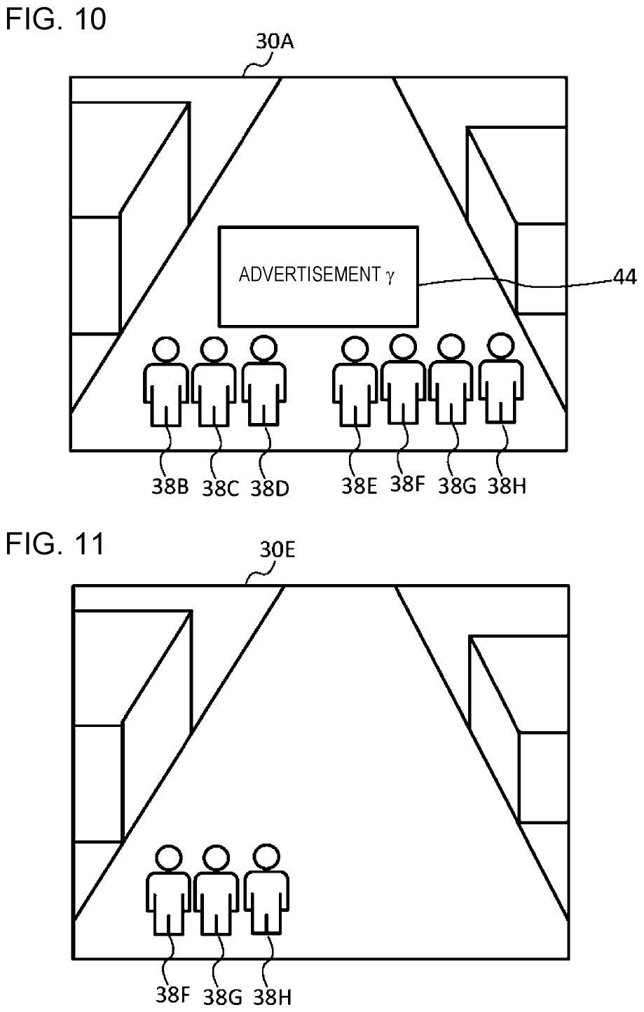

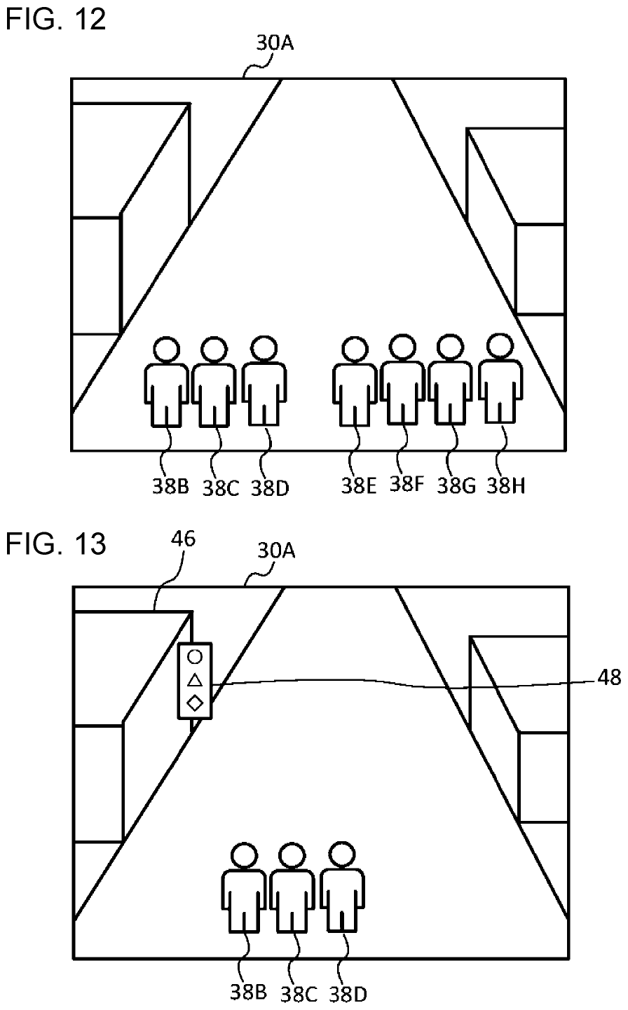

This will be explained in detail by taking a specific example. If a certain user (user E, for example) in group B is a paying user, the processor 20 of the server 10 does not output advertising information to users E, F, G, and H in group B. Then, as shown in FIG. 11, advertising information is not displayed on the screen 30E of the terminal apparatus 12E of user E. Likewise, advertising information is not displayed on the screens of the terminal apparatuses 12F, 12G, and 12H of users F, G, and H. If there is no paying user in group B, the processor 20 outputs advertising information to group B.

The processor 20 may not output advertising information if at least a predetermined number of users in a group are paying users. For example, if half or more than half of users E, F, G, and H in group B are paying users, the processor 20 does not output advertising information to group B. If less than half of users E, F, G, and H are paying users, the processor 20 outputs advertising information to group B.

If the charging fee (a total fee, for example) for users E, F, G, and H is a predetermined amount or higher, the processor 20 may not output advertising information to group B. If the charging fee for users E, F, G, and H is less than the predetermined amount, the processor 20 outputs advertising information to group B.

When group A and group B interact with each other, the processor 20 may determine whether to output advertising information, depending on whether a paying user is included in group A and group B. For example, if there is a paying user in group A and group B interacting with each other, the processor 20 does not output advertising information to group A and group B. In this case, as shown in FIG. 12, advertising information is not displayed on the screen 30A of user A. Advertising information is not displayed on the displays of user B through H, either. If at least a predetermined number of paying users are included in group A and group B, advertising information may not be output. The processor 20 may determine whether to output advertising information in accordance with the charging fee for users A through H.

The processor 20 of the server 10 may output attention drawing information to a group including a paying user.

If a certain group includes even one paying user, the processor 20 may output attention drawing information to this group and may not output attention drawing information to a group without any paying user. If a group includes at least a predetermined number of paying users, the processor 20 may output attention drawing information to this group. If a group includes paying users less than the predetermined number, the processor 20 may not output attention drawing information to this group. The processor 20 may determine whether to output attention drawing information to a group in accordance with the charging fee for the entire group.

This will be explained in detail by taking a specific example. If a certain user (user A, for example) in group A is a paying user, the processor 20 of the server 10 outputs advertising information to users A, B, C, and D in group A. Then, advertising information is displayed on the screens of the terminal apparatuses 12A, 12B, 12C, and 12D of users A, B, C, and D. If there is no paying user in group A, the processor 20 does not output advertising information to group A.

The processor 20 may output advertising information if at least a predetermined number of users in a group are paying users. For example, if half or more than half of users A, B, C, and D in group A are paying users, the processor 20 outputs advertising information to group A. If less than half of users A, B, C, and D are paying users, the processor 20 does not output advertising information to group A.

If the charging fee (a total fee, for example) for users A, B, C, and D is a predetermined amount or higher, the processor 20 may output advertising information to group A. If the charging fee for users A, B, C, and D is less than the predetermined amount, the processor 20 may not output advertising information to group A.

When group A and group B interact with each other, the processor 20 may determine whether to output advertising information, depending on whether a paying user is included in group A and group B. For example, if there is a paying user in group A and group B interacting with each other, the processor 20 outputs advertising information to group A and group B. If at least a predetermined number of users A through H are paying users, advertising information may be displayed. The processor 20 may determine whether to output advertising information in accordance with the charging fee for users A through H.

FIG. 13 shows a screen 30A of the terminal apparatus 12A of user A. A real townscape is recreated in an online space of an online service, such as an online game, and is displayed on the screen 30A. On the screen 30A, an image of a building 46 and an image of a road in a real space are displayed. On the screens of the terminal apparatuses 12 of the other users, an image of a building and that of a road in the real space are also displayed.

If a paying user or at least a predetermined number of paying users are included in group A or if the charging fee for group A is a predetermined amount or higher, advertising information is displayed on the screen 30A. For example, the advertising information is information indicating an advertisement in a real space. For example, an advertising sign 48 placed on the building 46 is an advertising sign placed on the actual building in the real space, and the image of the advertising sign 48 is displayed on the screen 30A. In this manner, a townscape in a real space is recreated in an online space. On the screens of the terminal apparatuses 12B, 12C, and 12D of users B, C, and D in group A, the image of the advertising sign 48 is also displayed in a manner similar to that on the screen 30A.

In contrast, if no paying user or less than the predetermined number of paying users are included in group B or if the charging fee for group B is less than the predetermined amount, the processor 20 of the server 10 does not provide an advertisement in a real space to group B. For example, instead of the image of the advertising sign 48, an image of an advertising sign with a fictitious trademark, for example, is displayed on the terminal apparatuses 12 of the users in group B.

For the sake of description, an example in which two groups (group A and group B) use the same online service has been discussed. When three or more groups use the same online service, the above-described processing is also executed.

Processing in the second example may be executed in an online service other than an online game. For example, if multiple users are participating in the same online meeting as a group, the same attention drawing information, such as the same advertising information, is provided to this group. If multiple groups interact with each other in an online meeting, the same attention drawing information is provided to these groups. In another example, if plural users are receiving the content, such as a concert, a live show, or a movie, online as a group, the same attention drawing information is provided to this group.

### Third Example

A third example will be described below.

In the third example, the processor 20 of the server 10 outputs the same attention drawing information to plural users working together by using the same online service.

It is now assumed that user A and user B are working together by using the same online service. The online service is a service for providing one or plural applications to a user. The online service is also a service for providing a function of enabling multiple users to work together by using one or plural applications.

The processor 20 of the server 10 has a function of detecting and recognizing which application is being used (started) in each terminal apparatus 12. Such an application may be software provided by an online service or software provided in a form other than an online service (such as software preinstalled in the terminal apparatus 12).

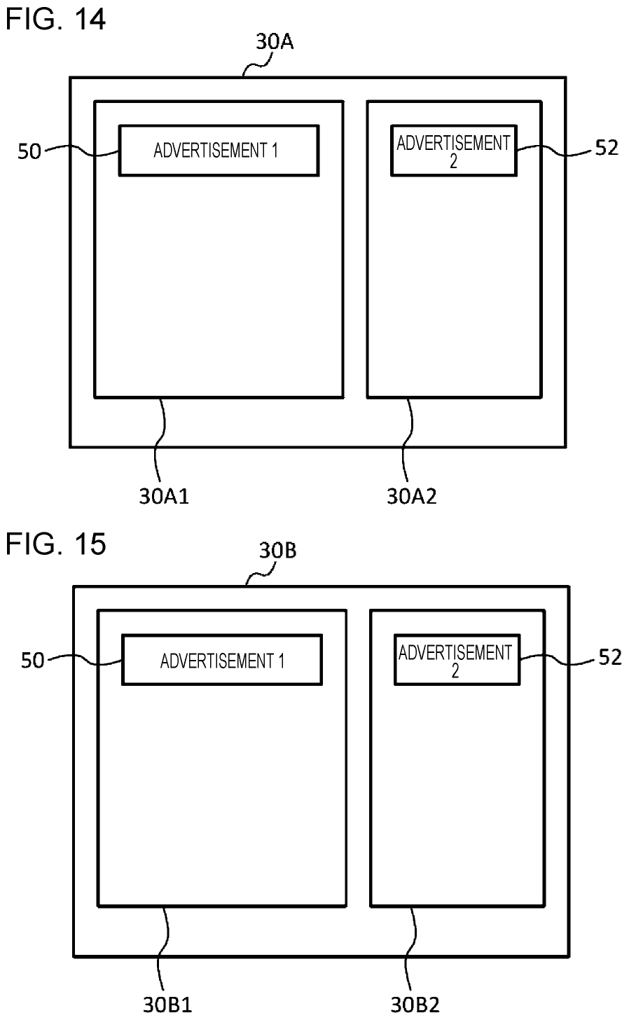

The third example will be explained below in detail with reference to FIGS. 14 and 15. FIG. 14 shows a screen 30A displayed on the display of the terminal apparatus 12A of user A. FIG. 15 shows a screen 30B displayed on the display of the terminal apparatus 12B of user B.

User A and user B are working together by using the same online service.

On the screen 30A shown in FIG. 14, display regions 30A1 and 30A2 are formed.

The display region 30A1 is a region (a window, for example) for a user to do work by using application software X. When application software X is started, the display region 30A1 is displayed. If application software X is a document creating application, a user can form a document by using application software X. In the display region 30A1, a document to be formed (such as a document being created or edited by a user) is displayed. Application software X is software to be provided by an online service. For example, user A logs in an online service and forms a document by using application software X.

The display region 30A2 is a region (a window, for example) for a user to do work by using application software Y. When application software Y is started, the display region 30A2 is displayed. If application software Y is a web browser, a website is displayed in the display region 30A2. Application software Y may be software provided online or software provided in a form other than an online service (such as software preinstalled in the terminal apparatus 12A). If application software Y is provided by an online service, user A logs in the online service and visits the website by using application software Y.

The display regions 30A1 and 30A2 may be formed on the same display screen or on different display screens.

On the screen 30B shown in FIG. 15, display regions 30B1 and 30B2 are formed.

The display region 30B1 is a region (a window, for example) for a user to do work by using application software X. When application software X is started, the display region 30B1 is displayed. In the display region 30B1, a document to be formed is displayed. Application software X is software provided online. For example, user B logs in an online service and forms a document by using application software X.

The display region 30B2 is a region (a window, for example) for a user to do work by using application software Y. When application software Y is started, the display region 30B2 is displayed. A website is displayed in the display region 30B2. Application software Y may be software provided by an online service or software provided in a form other than an online service (such as software preinstalled in the terminal apparatus 12B). If application software Y is provided by an online service, user B logs in the online service and visits the website by using application software Y.

The display regions 30B1 and 30B2 may be formed on the same display screen or on different display screens.

When application software X and application software Y are running in the terminal apparatuses 12A and 12B, the processor 20 of the server 10 can detect this state.

Application software X is software that can be used by multiple users. Multiple users can create a document together by using application software X.

It is now assumed that user A and user B are forming a document together by using the same application software X. The document is displayed in the display region 30A1 on the screen 30A and in the display region 30B1 on the screen 30B. If user A has edited the document by using application software X, for example, the resulting document is displayed in the display regions 30A1 and 30B1.

When user A and user B are working together online by using the same application software X in this manner, the processor 20 of the server 10 outputs the same attention drawing information to user A and user B. For example, the processor 20 sends the same advertising information 50 to the terminal apparatuses 12A and 12B and displays it in the display regions 30A1 and 30B1, which serve as work areas for user A and user B using application software X. The advertising information 50 indicates an image of advertisement 1, for example. As shown in FIG. 14, the advertising information 50 is displayed in the display region 30A1. As shown in FIG. 15, the advertising information 50 is displayed in the display region 30B1. As a result, the same advertisement is provided to user A and user B working together.

If multiple users working together by using the same online service also uses an application other than this online service, the processor 20 of the server 10 may output the same attention drawing information by using this application. The application used by one user and that by another user may be the same application or different applications.

This processing will be explained below in detail with reference to FIGS. 14 and 15. If user A and user B are forming a document together by using application software X, the processor 20 of the server 10 outputs the same advertising information by using an application other than application software X. Since user A and user B use application software Y, the processor 20 outputs the same advertising information by using application software Y. For example, the processor 20 outputs advertising information 52 indicating advertisement 2 to the terminal apparatuses 12A and 12B and displays it in the display regions 30A2 and 30B2, which are work areas for user A and user B using application software Y. Then, as shown in FIG. 14, the advertising information 52 is displayed in the display region 30A2, and as shown in FIG. 15, the advertising information 52 is displayed in the display region 30B2. As a result, the same advertisement is provided with an application other than application software X used by user A and user B to work together.

If user A or user B uses application software Z other than application software Y, the same advertising information may be displayed by using application software Y and application software Z. For example, if user A uses application software Y and user B uses application software Z, the display region 30A2 is a region for application software Y, while the display region 30B2 is a region for application software Z. In this case, too, the same advertising information 52 is displayed in the display regions 30A2 and 30B2.

In this manner, even when user A and user B use different applications, the same advertisement can be provided to user A and user B.

For example, if user A and user B are using the same online service with account information provided by social media or by the same company and also use applications different from each other, the same advertisement may be provided to user A and user B.

If multiple users working together by using the same online service are conducting a search by using an application, the processor 20 of the server 10 may output the same attention drawing information to these users in accordance with a common characteristic of keywords used for the search by the users.

This processing will be explained below in detail with reference to FIGS. 14 and 15.

User A is searching a website by using application software Y, which is a web browser. For example, a search site is displayed in the display region 30A2, and user A inputs a keyword in the search site to give a search instruction. Then, application software Y searches the website by using the input keyword as a search key and displays a search result in the display region 30A2. Information indicating the keyword used for a search and information indicating the search result are sent from the terminal apparatus 12A to the server 10.

Likewise, user B is searching a website by using application software Y, which is a web browser. For example, a search site is displayed in the display region 30B2, and user B inputs a keyword in the search site to give a search instruction. Then, application software Y searches the website by using the input keyword as a search key and displays a search result in the display region 30B2. Information indicating the keyword used for a search and information indicating the search result are sent from the terminal apparatus 12B to the server 10.

The processor 20 of the server 10 outputs the same attention drawing information to user A and user B working together by using the same online service, in accordance with a common characteristic of the keywords used for a search by user A and user B.

For example, if user A and user B are conducting a search by using the same keyword, the processor 20 outputs the same advertising information to the terminal apparatuses 12A and 12B and displays the advertising information in the display regions 30A2 and 30B2.

If plural keywords used for a search by user A and those by user B include at least a predetermined number of identical keywords, the processor 20 may send the same advertising information to the terminal apparatuses 12A and 12B and display the advertising information in the display regions 30A2 and 30B2.

If one or plural keywords used for a search by user A and one or plural keywords used for a search by user B have a predetermined relationship, the processor 20 may send the same advertising information to the terminal apparatuses 12A and 12B and display the advertising information in the display regions 30A2 and 30B2.

A search using a keyword may be a search for information other than that in a website. For example, a search using a keyword may be a search for a word in a document (document on which users are working together).

Another example of the third example will be described below.

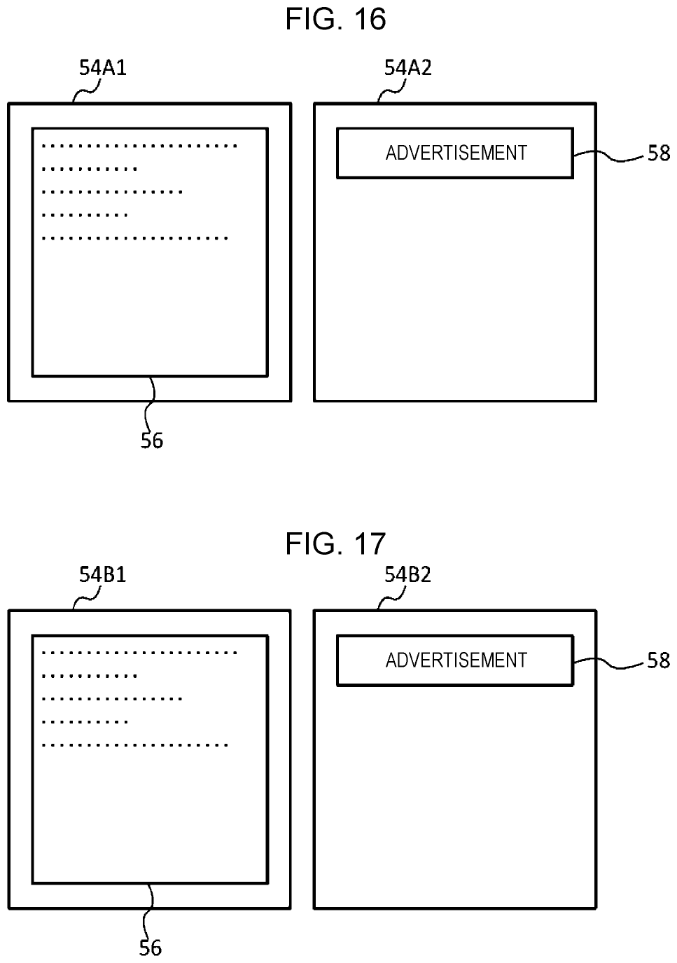

FIG. 16 shows screens 54A1 and 54A2 to be provided to user A. The screens 54A1 and 54A2 may be displayed on the same display of the terminal apparatus 12A of user A or on different displays used by user A or on displays of different terminal apparatuses 12A used by user A.

FIG. 17 shows screens 54B1 and 54B2 to be provided to user B. The screens 54B1 and 54B2 may be displayed on the same display of the terminal apparatus 12B of user B or on different displays used by user B or on displays of different terminal apparatuses 12B used by user B.

In a manner similar to the scene discussed with reference to FIGS. 14 and 15, user A and user B have logged in the same online service and are editing a document 56 together by using a document creating application. The document 56 is displayed on the screens 54A1 and 54B1. User A and user B can edit the document 56 by using their own terminal apparatuses 12. If user A has edited the document 56, the resulting document 56 is displayed on the screens 54A1 and 54B1. Similarly, if user B has edited the document 56, the resulting document 56 is displayed on the screens 54A1 and 54B1.

A website is displayed on the screens 54A2 and 54B2. If user A has conducted a search with a web browser, for example, the processor 20 of the server 10 displays the same advertising information 58 on the screens 54A2 and 54B2. If user B has conducted a search, the same advertising information 58 is also displayed on the screens 54A2 and 54B2. In this manner, as a result of user A or user B conducting a search, the same advertisement is provided to user A and user B.

The processor 20 of the server 10 may change a piece of attention drawing information to be provided to users in accordance with the content of work that the users are doing together. In the example in FIGS. 16 and 17, the processor 20 changes an advertisement to be provided to user A and user B in accordance with the editing content of the document 56. For example, the processor 20 changes the content of the advertising information 58 displayed on the screens 54A2 and 54B2. If the document 56 is an apparel-related topic, such as about designing, the processor 20 displays advertising information 58 indicating an apparel-related advertisement on the screens 54A2 and 54B2. If the document 56 is a game-related topic, such as a description or a comment of a game, the processor 20 displays advertising information 58 indicating a game-related advertisement on the screens 54A2 and 54B2.

The processor 20 extracts text or an image included in the document 56, analyzes it, predicts the content of the document 56, and then displays advertising information 58 based on the content of the document 56 on the screens 54A2 and 54B2. To analyze text or images, a known technology may be used.

For the sake of description, an example in which two users (user A and user B) work together using the same online service has been discussed. When three or more users work together using the same online service, the above-described processing is also executed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a memory storing a plurality of pieces of advertising information; and
a processor configured to:
detect a first plurality of user terminals based on the first plurality of user terminals (i) using an identical online service, and (ii) together forming a first electronic document using the identical online service; and
in response to detecting the first plurality of user terminals,
determine a first piece of advertising information to be output using a network based on an analysis of information associated with a user of at least one of the first plurality of user terminals,
output the first piece of advertising information, from the memory, to the first plurality of user terminals, and
cause a display of each of the first plurality of user terminals to be updated to display the first piece of advertising information together with the first electronic document.

2. The information processing apparatus according to claim 1, wherein the processor is configured to output the first piece of advertising information to the first plurality of user terminals using the identical online service in an identical span of time.

3. The information processing apparatus according to claim 1, wherein:
the first plurality of user terminals is formed into a group; and
the processor is configured to output the first piece of advertising information to the first plurality of user terminals forming the group.

4. The information processing apparatus according to claim 2, wherein:
the first plurality of user terminals is formed into a group; and
the processor is configured to output the first piece of advertising information to the first plurality of user terminals forming the group.

5. The information processing apparatus according to claim 3, wherein the processor is configured to output the first piece of advertising information to a plurality of groups related to each other, the plurality of groups including the group formed by the first plurality of user terminals.

6. The information processing apparatus according to claim 4, wherein the processor is configured to output the first piece of advertising information to a plurality of groups related to each other, the plurality of groups including the group formed by the first plurality of user terminals.

7. The information processing apparatus according to claim 5, wherein the plurality of groups related to each other are a plurality of groups interacting with each other by using the identical online service.

8. The information processing apparatus according to claim 6, wherein the plurality of groups related to each other are a plurality of groups interacting with each other by using the identical online service.

9. The information processing apparatus according to claim 5, wherein the processor is configured to determine the first piece of advertising information in accordance with how the plurality of groups are related to each other.

10. The information processing apparatus according to claim 6, wherein the processor is configured to determine the first piece of advertising information in accordance with how the plurality of groups are related to each other.

11. The information processing apparatus according to claim 3, wherein the processor is configured to output, when any one of the user terminals of the first plurality of user terminals performs an operation on the first piece of advertising information, information to be advertised based on the first piece of advertising information to the group.

12. The information processing apparatus according to claim 3, wherein the processor is configured not to output the first piece of advertising information to another group including a user terminal paying for using the identical online service.

13. The information processing apparatus according to claim 3, wherein the group includes a user terminal paying for the identical online service.

14. The information processing apparatus according to claim 1, wherein the first plurality of user terminals includes a user terminal paying for the identical online service.

15. (canceled)

16. The information processing apparatus according to claim 1, wherein the processor is configured to output, if the first plurality of user terminals also use an application other than the identical online service, the first piece of advertising information to the first plurality of user terminals by using the application.

17. The information processing apparatus according to claim 1, wherein the processor is configured to output, if each of the first plurality of user terminals conducts a search by using an application, the first piece of advertising information to the first plurality of user terminals in accordance with a common characteristic of keywords used for the searches by the first plurality of user terminals.

18. The information processing apparatus according to claim 1, wherein the processor is configured to determine the first piece of advertising information to be output to the first plurality of user terminals in accordance with content of the first electronic document.

19. An information processing system comprising:
a first user terminal including a first display and a first processor configured to (i) use an identical online service and (ii) form a first electronic document using the identical online service;
a second user terminal including a second display and a second processor configured to (i) use the identical online service and (ii) form the first electronic document using the identical online service together with the first user terminal; and
a server including a third processor and a memory storing a plurality of pieces of advertising information, wherein
the third processor is configured to
detect a first plurality of user terminals, including the first user terminal and the second user terminal, based on the first plurality of user terminals (i) using the identical online service, and (ii) together forming the first electronic document using the identical online service, and
in response to detecting the first plurality of user terminals,
determine a first piece of advertising information to be output using a network based on an analysis of information associated with a user of at least one of the first plurality of user terminals, and
output the first piece of advertising information, from the memory, to the first plurality of user terminals via the network,
the first processor is configured to
receive the first piece of advertising information from the third processor via the network, and
update the first display to display the first piece of advertising information together with the first electronic document, and
the second processor is configured to
receive the first piece of advertising information from the third processor via the network, and
update the second display to display the first piece of advertising information together with the first electronic document.

20. A non-transitory computer readable medium storing a program causing a computer, that includes (i) a memory storing a plurality of pieces of advertising information and (ii) a processor, to execute a process, the process comprising:
detecting a first plurality of user terminals based on the first plurality of user terminals (i) using an identical online service, and (ii) together forming a first electronic document using the identical online service; and
in response to detecting the first plurality of user terminals,
determining a first piece of advertising information to be output using a network based on an analysis of information associated with a user of at least one of the first plurality of user terminals,
outputting the first piece of advertising information, from the memory, to the first plurality of user terminals, and
causing a display of each of the first plurality of user terminals to be updated to display the first piece of advertising information together with the first electronic document.
